(19) United States
(12) Patent Application Publication
(10) Pub. No.: US 2017/0187098 A1
(43) Pub. Date: Jun. 29, 2017

(54) TRANSMISSION APPARATUS, WIRELESS COMMUNICATION APPARATUS, AND WIRELESS COMMUNICATION SYSTEM

(71) Applicant: FUJITSU LIMITED, Kawasaki-shi (JP)

(72) Inventor: Hiroshi ASHIDA, Fujisawa (JP)

(73) Assignee: FUJITSU LIMITED, Kawasaki-shi (JP)

(21) Appl. No.: 15/377,006

(22) Filed: Dec. 13, 2016

(30) Foreign Application Priority Data
Dec. 24, 2015 (JP) 2015-252356

(51) Int. Cl. H01Q 1/24; H01Q 9/04; H01Q 1/22; H01Q 1/48

(52) U.S. Cl. CPC H01Q 1/243; H01Q 1/48; H01Q 9/0485; H01Q 9/0407; H01Q 1/2283

(57) ABSTRACT

A transmission apparatus includes a first metal plate including a first surface, a second surface opposite to the first surface, and a first through hole penetrating from the first surface to the second surface, the first metal plate; a first board being disposed on the first surface side of the first metal plate, the first board including a first patch antenna positioned inside the first through hole; and a second board being disposed on the second surface side of the first metal plate, the second board including a second patch antenna positioned inside the first through hole and opposed to the first patch antenna, wherein an interval between the first patch antenna and the second patch antenna is set in accordance with a distance for wireless communicating between the first patch antenna and the second patch antenna in a near field.

### CROSS-REFERENCE TO RELATED APPLICATION

This application is based upon and claims the benefit of priority of the prior Japanese Patent Application No. 2015-252356, filed on Dec. 24, 2015, the entire contents of which are incorporated herein by reference.

### FIELD

The embodiments discussed herein are related to a transmission apparatus, a wireless communication apparatus, and a wireless communication system.

### BACKGROUND

There is provided a conventional planar antenna module including an antenna section, a feeder line section, and a connecting conductor. The antenna section includes a first ground conductor having a first slot, a second ground conductor having dielectrics, an antenna substrate having a radiation element, a third ground conductor having dielectrics, and a fourth ground conductor. The feeder line section includes the fourth ground conductor, a fifth ground conductor, a feeder substrate, a sixth ground conductor, and a seventh ground conductor. The connecting conductor includes a second waveguide opening. The planar antenna module is formed by stacking the connecting conductor to be connected with a high frequency circuit, the seventh ground conductor, the sixth ground conductor, the feeder substrate, the fifth ground conductor, the fourth ground conductor, the third ground conductor, the antenna substrate, the second ground conductor, and the first ground conductor in this order (see, for example, International Publication Pamphlet No. WO 2006/098054).

### SUMMARY

According to an aspect of the invention, a transmission apparatus includes a first metal plate including a first surface, a second surface opposite to the first surface, and a first through hole penetrating from the first surface to the second surface, the first metal plate being maintained at a reference potential; a first board being disposed on the first surface side of the first metal plate, the first board including a first patch antenna positioned inside the first through hole in a plan view; and a second board being disposed on the second surface side of the first metal plate, the second board including a second patch antenna positioned inside the first through hole in the plan view and opposed to the first patch antenna, wherein an interval between the first patch antenna and the second patch antenna is set in accordance with a distance for wireless communicating between the first patch antenna and the second patch antenna in a near field.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIGS. 1A and 1B are diagrams illustrating a wireless communication apparatus and a wireless communication system including transmission apparatus according to a first embodiment;

FIG. 2 is a transparent perspective view illustrating the transmission apparatus according to the first embodiment;

FIG. 3 is an exploded view of the transmission apparatus illustrated in FIG. 2;

FIG. 4 is a diagram illustrating a cross-section viewed in the direction of arrows A in FIG. 2;

FIG. 5 is a graph illustrating results of a simulation indicating a relationship between each of an electric field intensity and a transmission loss against an interval;

FIGS. 6A and 6B are diagrams illustrating a model of simulation of the transmission apparatus;

FIGS. 7A and 7B are each a graph illustrating results of a simulation of S-parameters and a bandwidth;

FIG. 8 is a diagram illustrating dependence of a resonant frequency, the S-parameters, BW1, BW2, BW4, and BW when the interval is changed;

FIG. 9 is a transparent perspective view illustrating transmission apparatus according to a second embodiment;

FIG. 10 is an exploded view of the transmission apparatus illustrated in FIG. 9;

FIG. 11 is a cross-section viewed in the direction of arrows B in FIG. 9;

FIGS. 12A and 12B are diagrams illustrating a model of simulation of the transmission apparatus;

FIGS. 13A and 13B are each a graph illustrating results of a simulation of the S-parameters and the bandwidth;

FIG. 14 is a diagram illustrating dependence of the resonant frequency, the S-parameters, BW1, BW4, and BW on a diameter b of through holes;

FIG. 15 is a model of simulation of transmission apparatus according to a first modified example of the second embodiment;

FIGS. 16A and 16B are each a graph illustrating results of a simulation of the S-parameters and the bandwidth;

FIG. 17 is a diagram illustrating dependence of the resonant frequency, the S-parameters, BW1, BW4, and BW on displacement;

FIG. 18 is a graph illustrating results of a simulation of the S-parameters and the bandwidth in a second modified example of the second embodiment;

FIG. 19 is a diagram illustrating dependence of the resonant frequency, the S-parameters, BW1, BW4, and BW in the second modified example of the second embodiment; and

FIG. 20 is a cross-sectional view of transmission apparatus according to a third embodiment, and illustrates a cross-section corresponding to the cross-section illustrated in FIG. 4.

### DESCRIPTION OF EMBODIMENTS

A conventional planar antenna module includes a waveguide. Since the waveguide has to be long to some extent, the conventional planar antenna module has a problem that its downsizing is difficult.

Given the circumstances, an object of the disclosure is to provide downsized transmission apparatus, a downsized wireless communication apparatus, and a downsized wireless communication system.

Hereinbelow, embodiments will be described to which transmission apparatus, a wireless communication apparatus, and a wireless communication system according to the disclosure are applied.

### First Embodiment

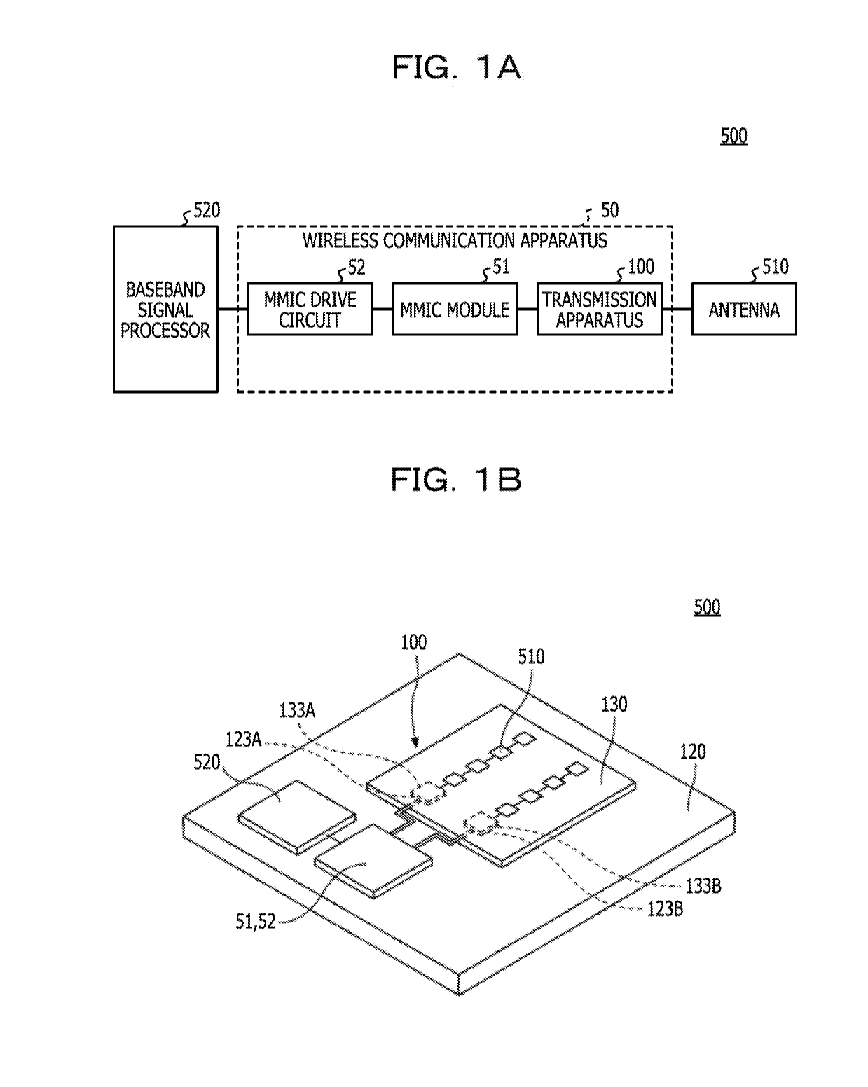

FIGS. 1A and 1B are diagrams illustrating a wireless communication apparatus 50 and a wireless communication system 500 including transmission apparatus 100 according to a first embodiment. FIG. 1A is a block diagram, and FIG. 1B is a perspective view illustrating an example of an implementation state.

As illustrated in FIG. 1A, the wireless communication system 500 includes an antenna 510, the wireless communication apparatus 50, and a baseband signal processor 520.

The wireless communication apparatus 50 includes the transmission apparatus 100, a monolithic microwave integrated circuit (MMIC) module 51, and an MMIC drive circuit 52.

The MMIC module 51 is a device which is connected to the transmission apparatus 100 and performs RF front end processing. Integrated on the MMIC module 51 are an amplifier, a mixer, an oscillator (voltage-controlled oscillator or VCO), a multiplexer, and other components. The MMIC module 51 generates a high frequency signal in the millimeter wave band (hereinafter referred to as a millimeter wave) to be transmitted from the antenna 510, and calculates the difference in frequency between a reflection signal received by the antenna 510 and the high frequency signal thus transmitted.

The MMIC drive circuit 52 is a circuit which drives the MMIC module 51.

The baseband signal processor 520 processes low frequency components, which depend on the difference in frequency, and extracts the requested information. The baseband signal processor 520 is an example of a signal processor.

Since the transmission apparatus 100 of the wireless communication apparatus 50 has a favorable small transmission loss and an isolation characteristic even with a simple configuration, the wireless communication apparatus 50 is possible to achieve its downsizing and cost reduction.

Regarding the wireless communication system 500, in the meantime, two wireless communication systems 500 may be employed to perform communication between the wireless communication systems 500 using millimeter waves. The communication with use of millimeter waves makes it possible to narrow directivity, which facilitates multichanneling.

It is to be noted that the wireless communication system 500 may be used as a radar device. The distance toward an object may be measured based on the difference in time between a radio wave emitted by the wireless communication system 500 from the antenna 510 and a received radio wave. Also, it is possible to detect, based on differences in distance, a direction toward the object by measuring the distances toward the object using multiple antennae 510 arranged in parallel, if the transmission apparatus 100 has transmission paths corresponding to multiple channels and the wireless communication system 500 includes antennae 510 corresponding to the multiple channels.

In addition, as illustrated in FIG. 1B, the wireless communication system 500 has the antenna 510 mounted on a surface of a board 130 of the transmission apparatus 100, and the MMIC module 51, the MMIC drive circuit 52, and the baseband signal processor 520 mounted on a surface of a board 120, for example. Note that in FIG. 1B, the MMIC module 51 and the MMIC drive circuit 52 are illustrated as a single component.

The transmission apparatus 100 includes patch antennae 123A, 123B, 133A, and 133B. The patch antennae 123A and 123B are disposed between layers forming the board 120. The patch antennae 133A and 133B are disposed between layers forming the board 130.

Here, wiring boards of flame retardant type 4 (FR-4) may be used as the boards 120 and 130. The MMIC module 51, the MMIC drive circuit 52, and the baseband signal processor 520 are mounted on the board 120, while the antenna 510 is mounted on the board 130. In other words, the board 120 is used as a motherboard, and the board 130 is used as a board for disposing the antenna 510.

The permittivity of the dielectric layers included in the boards 120 and that of the dielectric layers included in the board 130 may be equal to each other, but may be different from each other because the boards 120 and 130 are devoted to different purposes as described above. The permittivity of the dielectric layers of the board 130, on which the antenna 510 is disposed, may be set less than that of the dielectric layers of the board 120.

The patch antennae 123A and 133A are connected by being disposed opposite to and close to each other, making it possible to perform communication therebetween in the near field. The patch antennae 123A and 133A establish a transmission path between the boards 120 and 130.

Likewise, the patch antennae 123B and 133B are connected by being disposed opposite to and close to each other, making it possible to perform communication therebetween in the near field. The patch antennae 123B and 133B establish a transmission path between the boards 120 and 130.

The above configuration establishes the transmission paths corresponding to two channels between the boards 120 and 130. The configuration will be described later in which each of the pair of the patch antennae 123A and 133A, and the pair of the patch antennae 123B and 133B are communicably connected in the near field. Note that the mentioned number of channels is an example; it suffices that at least one channel is established between the boards 120 and 130.

The patch antennae 133A and 133B are connected to the antenna 510. The antenna 510 is made up of eight patch antennae. Four of the eight patch antennae are connected in series to the patch antenna 133A, and the other four of the eight patch antennae are connected in series to the patch antenna 133B.

The patch antennae 123A and 123B are connected to the MMIC module 51. The MMIC module 51, in practice, is connected to the MMIC drive circuit 52 via a wiring layer formed on the surface of the board 120, and the MMIC drive circuit 52 is connected to the baseband signal processor 520 via the wiring layer formed on the surface of the board 120.

The pair of the patch antennae 123A and 133A and the pair of the patch antennae 123B and 133B establish the transmission paths corresponding to two channels. Thus, the antenna 510 and the MMIC module 51 are connected to each other via the transmission paths corresponding to the two channels and being established by the pair of the patch antennae 123A and 133A and the pair of the patch antennae 123B and 133B.

In the case where the transmission paths are established between the board 120 and the board 130 using, for example, two waveguides instead of the pair of the patch antennae 123A and 133A and the pair of the patch antennae 123B and 133B, it is difficult to downsize the transmission apparatus 100 since the waveguides are unsuitable for downsizing.

For such a reason, the transmission apparatus 100 according to the first embodiment adopts a configuration which establishes the transmission paths such that each of the pair of the patch antennae 123A and 133A and the pair of the patch antennae 123B and 133B are capable of communicate with each other in the near field. The transmission paths which allow communication in the near field as described above are so small that it is possible to downsize the transmission apparatus 100.

Hereinbelow, description is provided for the transmission apparatus 100.

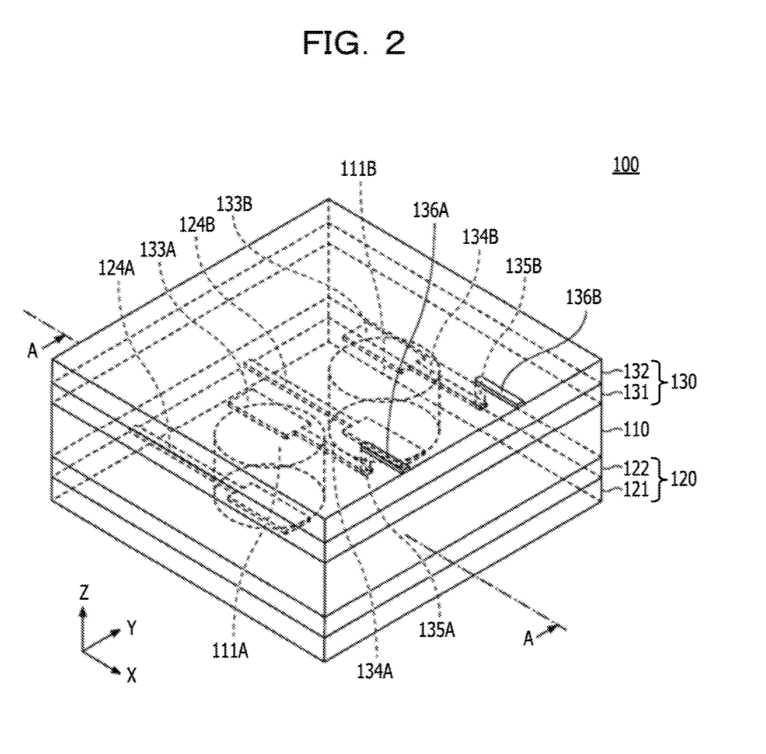

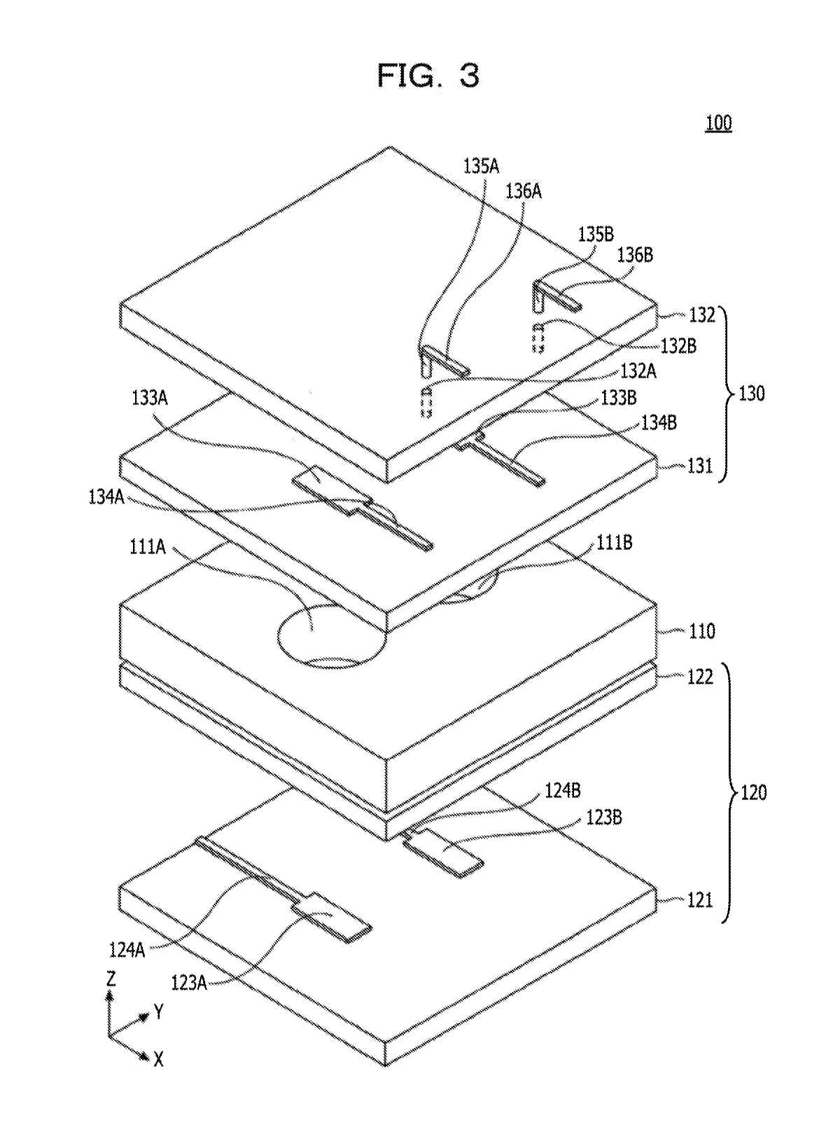

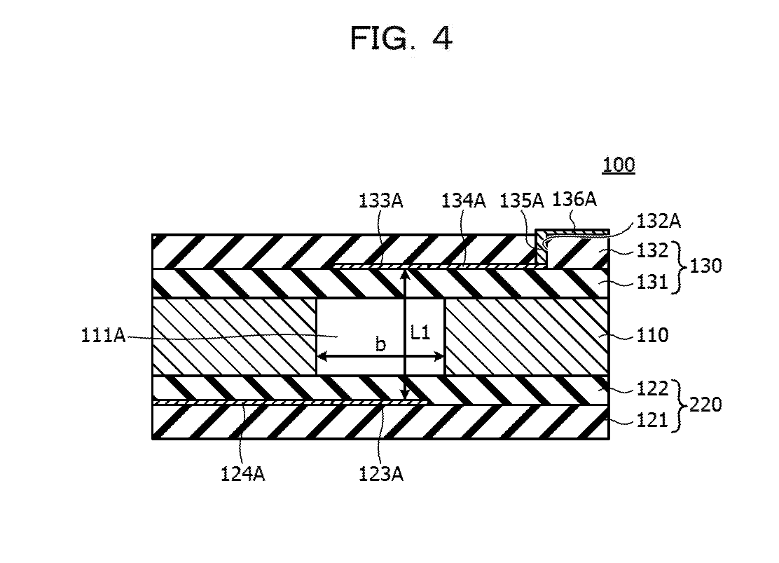

FIG. 2 is a transparent perspective view illustrating the transmission apparatus 100 according to the first embodiment. FIG. 3 is an exploded view of the transmission apparatus 100 illustrated in FIG. 2. FIG. 4 is a diagram illustrating a cross-section viewed in the direction of arrows A in FIG. 2.

In the description below, as illustrated in FIGS. 2 to 4, an XYZ coordinate system (orthogonal coordinate system) is defined. Here, a surface on the negative Z-axis direction side is referred to as a lower surface, and a surface on the positive Z-axis direction side as an upper surface. Besides, the negative Z-axis direction side is referred to as a lower side and the positive Z-axis direction side is referred to as an upper side. Note that the up-and-down relationship represented by the positive and negative Z-axis direction sides is for the sake of the convenience of explanation, but does not represent the general positional relationship.

Moreover, FIGS. 2 to 4 illustrate parts of the transmission apparatus 100. The transmission apparatus 100 may further extend in the XY plane directions.

The transmission apparatus 100 includes a metal plate 110, the board 120, and the board 130. Here, as an example, transmission paths corresponding to two channels and including the pair of the patch antennae 123A and 133A, and the pair of patch antennae 123B and 133B are illustrated.

The metal plate 110 has through holes 111A and 111B. The metal plate 110 may be, for example, a plate-shaped member made of a metal such as copper or aluminum. The metal plate 110 is an example of a first metal plate, the through holes 111A and 111B are each an example of a first through hole, a lower surface of the metal plate 110 is an example of a first surface, and an upper surface thereof is an example of a second surface.

The metal plate 110 is maintained at the ground potential. The metal plate 110 may be maintained at the ground potential by, for example, connecting the metal plate 110 to the wiring of the board 120 at the ground potential. The connection of the metal plate 110 to the wiring of the board 120 at the ground potential may be performed through, for example, a via penetrating the board 120 in the thickness direction. The connection may be performed through the via outside the region of the board 120 illustrated in FIGS. 2 to 4. Incidentally, the metal plate 110 may be connected to the wiring of the board 120 at the ground potential using a conductive wire or the like provided outside the board 120.

The through holes 111A and 111B penetrate the metal plate 110 in the Z-axis direction, and have a circular shape in an XY-plan view (hereinafter, in a plan view), for example. The size of open circle of each of the through holes 111A and 111B is set such that any of the patch antennae 123A, 123B, 133A, and 133B is enclosed in a plan view. Note that in the plan view, the sizes of the patch antennae 123A, 123B, 133A and 133B are equal.

The board 120 includes dielectric layers 121 and 122, the patch antennae 123A and 123B, and wires 124A and 124B. The board 120 is an example of a first board, and the patch antennae 123A and 123B are each an example of a first patch antenna. The board 120 may be an FR-4 printed board as an example.

As the dielectric layer 121, for example, a core material may be used which is formed by impregnating fiberglass with epoxy resin and then curing that epoxy resin. The patch antennae 123A and 123B, and the wires 124A and 124B are disposed on an upper surface of the dielectric layer 121 as the core material.

In the case of using the core material as the dielectric layer 121, a prepreg layer may be used as the dielectric layer 122, for example, which is formed by impregnating fiberglass with epoxy resin.

The patch antennae 123A and 123B are disposed on the upper surface of the dielectric layer 121. Alignment is performed such that the patch antenna 123A is disposed, in a plan view, inside the through hole 111A in the metal plate 110, and the patch antenna 123B is disposed, in a plan view, inside the through hole 111B in the metal plate 110.

The patch antennae 123A and 123B are each an example of the first patch antenna. In this case, two first patch antennae are provided. The patch antennae 123A and 123B may be made of a metal such as copper or aluminum. In the following, embodiments will be described in which the patch antennae 123A and 123B are made of copper.

The patch antennae 123A and 123B each have a rectangular shape (shape of an rectangle) in the plan view, and have a longitudinal direction in the X-axis direction. The length of each of the patch antennae 123A and 123B in the longitudinal direction (X-axis direction) is set to an electrical length of half a wavelength λ (λ/2) at a resonant frequency. The width of each of the patch antennae 123A and 123B in the Y-axis direction may be set appropriately because the width affects the resistances of the patch antennae 123A and 123B.

In addition, the patch antennae 123A and 123B are positioned in the XY-plane to face the patch antennae 133A and 133B, respectively, via the through holes 111A and 111B.

Moreover, the patch antennae 123A and 123B are positioned with respect to the patch antennae 133A and 133B in the Z-axis direction, respectively, so as to be able to communicate with the patch antennae 133A and 133B in the near field.

The wires 124A and 124B are connected to the negative X-axis direction side of the patch antennae 123A and 123B, respectively. The MMIC module 51 is connected to the negative X-axis direction side of the wires 124A and 124B.

The wires 124A and 124B are connected to the negative X-axis direction side of the patch antennae 123A and 123B, respectively, and form microstrip lines together with the metal plate 110.

In the case of using the core material as the dielectric layer 121, the patch antennae 123A and 123B, and the wires 124A and 124B may be formed through patterning of copper foil to be attached on the upper surface of the dielectric layer 121 by, for example, photolithography and wet etching.

Fabrication of the board 120 is completed by mounting and thermocompression bonding the dielectric layer 122 to the upper surface of the dielectric layer 121 in the state where the patch antennae 123A and 123B, and the wires 124A and 124B are disposed on the dielectric layer 121.

Incidentally, a prepreg layer may be used as the dielectric layer 121, and the core material may be used as the dielectric layer 122.

The board 130 includes dielectric layers 131 and 132, the patch antennae 133A and 133B, wires 134A and 134B, vias 135A and 135B, and wires 136A and 136B. The board 130 is an example of a second board, and the patch antennae 133A and 133B are each an example of a second patch antenna. The board 130 may be an FR-4 printed board as an example.

As the dielectric layer 131, for example, a core material may be used which is formed by impregnating fiberglass with epoxy resin and then curing that epoxy resin. The patch antennae 133A and 133B, and the wires 134A and 134B are disposed on an upper surface of the dielectric layer 131 as the core material.

In the case of using the core material as the dielectric layer 131, a prepreg layer may be used as the dielectric layer 132, for example, which is formed by impregnating fiberglass with epoxy resin.

The patch antennae 133A and 133B are disposed on the upper surface of the dielectric layer 131. Alignment is performed such that the patch antenna 133A is disposed, in the plan view, inside the through hole 111A in the metal plate 110, and the patch antenna 133B is disposed, in the plan view, inside the through hole 111B in the metal plate 110.

In addition, the patch antennae 133A and 133B are positioned in the XY-plane to face the patch antennae 123A and 123B, respectively, via the through holes 111A and 111B.

Moreover, the patch antennae 133A and 133B are positioned with respect to the patch antennae 123A and 123B in the Z-axis direction, respectively, so as to be able to communicate with the patch antennae 123A and 123B in the near field.

The patch antennae 133A and 133B are each an example of the second patch antenna. In this case, two second patch antennae are provided. The patch antennae 133A and 133B may be made of a metal such as copper or aluminum. In the following, embodiments will be described in which the patch antennae 133A and 133B are made of copper.

The patch antennae 133A and 133B each have a rectangular shape (shape of an rectangle) in the plan view, and have the longitudinal direction in the X-axis direction. The length of each of the patch antennae 133A and 133B in the longitudinal direction (X-axis direction) is set to an electrical length of half a wavelength λ (λ/2) at the resonant frequency. The width of each of the patch antennae 133A and 133B in the Y-axis direction may be set appropriately because the width affects the resistances of the patch antennae 133A and 133B.

The wires 134A and 134B are connected to the positive X-axis direction side of the patch antennae 133A and 133B, respectively. The vias 135A and 135B are connected to respective end portions on the positive X-axis direction side of the wires 134A and 134B.

The wires 134A and 134B are connected to the positive X-axis direction side of the patch antennae 133A and 133B, respectively, and form microstrip lines together with the metal plate 110.

The vias 135A and 135B are fabricated using plate layers formed on inner walls of two through holes 132A and 132B penetrating the dielectric layer 132 in the Z-axis direction. The plate layers may be a thin film plated with copper, and may be formed by plating the inner walls of the two through holes penetrating the dielectric layer 132 in the Z-axis direction. Lower ends of the vias 135A and 135B are connected to the respective end portions on the positive X-axis direction side of the wires 134A and 134B. Upper ends of the vias 135A and 135B are connected to the respective end portions on the negative X-axis direction side of the wires 136A and 136B.

The wires 136A and 136B are disposed on the upper surface of the dielectric layer 132. The wires 136A and 136B are provided for the purpose of connecting the vias 135A and 135B to the antenna 510 (see FIG. 1).

In the case of using the core material as the dielectric layer 131, the patch antennae 133A and 133B, and the wires 134A and 134B may be formed through patterning of copper foil to be attached on the upper surface of the dielectric layer 131 by, for example, photolithography and wet etching.

The vias 135A and 135B may be formed by fabricating two through holes penetrating the dielectric layer 132 in the Z-axis direction, and plating the inner walls of the two through holes. The wires 136A and 136B may be formed through patterning of copper foil attached on the upper surface of the dielectric layer 132 by, for example, photolithography and wet etching.

Fabrication of the board 130 is completed by mounting and thermocompression bonding the dielectric layer 132 including the vias 135A and 135B and the wires 136A and 136B to the upper surface of the dielectric layer 131 in the state where the patch antennae 133A and 133B, and the wires 134A and 134B are disposed on the dielectric layer 131. Note that the patterning of the wires 136A and 136B may be performed after the thermocompression bonding of the dielectric layer 131 and the dielectric layer 132.

Now, description will be provided for an interval in the Z-axis direction between the patch antennae 123A and 133A, and an interval in the Z-axis direction between the patch antennae 123B and 133B.

As illustrated in FIG. 4, the interval in the Z-axis direction between the patch antennae 123A and 133A is denoted by L1. Likewise, the interval in the Z-axis direction between the patch antennae 123B and 133B is denoted by L1.

In order to make possible communication between the patch antennae 123A and 133A in the near field, the interval L1 has to be such that the patch antennae 123A and 133A are communicably connected in the near field. This is the case when communication is to be established between the patch antennae 123B and 133B in the near field.

To achieve the above condition, the interval L1 has to be less than the interval corresponding to the boundary between the near field and the far field. In other words, the patch antenna 123A has to be disposed closer to the patch antenna 133A than the boundary between the near field and the far field is, and the patch antenna 133A has to be disposed closer to the patch antenna 123A than the boundary between the near field and the far field is.

The distance from each of the patch antennae 123A and 133A to the boundary between the near field and the far field may be represented by, for example, λ/2λ, where λ is the length of one wavelength of the frequency (communication frequency) at which the patch antennae 123A and 133A communicate with each other.

The dielectric layer 122, the through hole 111A, and the dielectric layer 131 are provided between the patch antennae 123A and 133A. Although air (atmosphere) is present inside the through hole 111A, the wavelength shortens inside the dielectric layer 122 and the dielectric layer 131. Thus, the value of λ may be an electrical length taking into consideration the shortening of the wavelength. In the case where the thicknesses of the dielectric layer 122 and the dielectric layer 131 in the Z-axis direction are sufficiently thin compared to the length of the through hole 111A in the Z-axis direction and thus are negligible, λ may be set to the length of one wavelength of the communication frequency in the air.

When the distance from each of the patch antennae 123A and 133A to the boundary between the near field and the far field is denoted by λ/2π, the interval L1 between the patch antennae 123A and 133A in the Z-axis direction may satisfy an expression (1) below:

L1<λ/2π (1).

In other words, the sum of the thicknesses of the dielectric layer 122, the through hole 111A, and the dielectric layer 131 may be less than λ/2π.

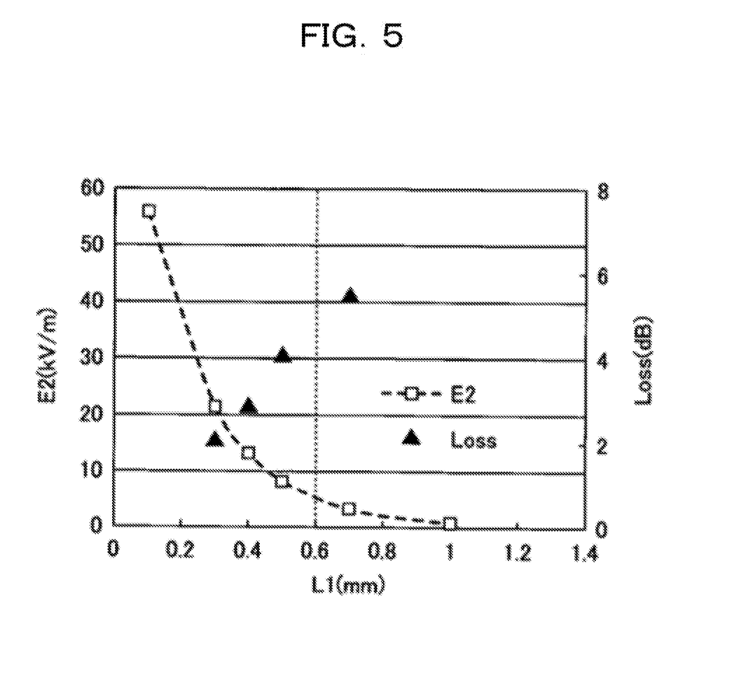

FIG. 5 is a graph illustrating results of a simulation indicating a relationship between each of an electric field intensity E2 and a transmission loss Loss against the interval L1.

The electric field intensity E2 represents the intensity of an electric field emitted from the patch antennae 123A and 123B, and the patch antennae 133A and 133B. The transmission loss Loss is a loss of transmission between the patch antenna 123A and 133A or between the patch antennae 123B and 133B.

The results of simulation illustrated in FIG. 5 were obtained with the communication frequency set to 78.0 GHz. One wavelength of 78.0 GHz is approximately 3.84 mm, and λ/2π is approximately 0.61 mm.

When the interval L1 was set to 0.3 mm, the electric field intensity E2 was approximately 21.7 KV/m, and the transmission loss Loss was approximately 2.1 dB.

When the interval L1 was set to 0.4 mm, the electric field intensity E2 was approximately 12.8 KV/m, and the transmission loss Loss was approximately 2.9 dB.

When the interval L1 was set to 0.5 mm, the electric field intensity E2 was approximately 8.3 KV/m, and the transmission loss Loss was approximately 4.1 dB.

When the interval L1 was set to 0.7 mm, the electric field intensity E2 was approximately 3 KV/m, and the transmission loss Loss was approximately 41 dB.

When the interval L1 was set to 1.0 mm, the electric field intensity E2 was approximately 1 KV/m, and the transmission loss Loss was a value greater than 60 dB.

The above results demonstrate that the electric field intensity E2 tends to decrease while the transmission loss Loss tends to increase as the interval L1 between the patch antennae 123A and 133A in the Z-axis direction increases.

Since the electric field intensity E2 (approximately 3 KV/m) obtained when the interval L1 is 0.7 mm is too weak for communication between the patch antennae 123A and 133A and between the patch antennae 123B and 133B, it is determined that the cases where the interval L1 is 0.3 mm, 0.4 mm, and 0.5 mm are favorable. Hence, considering the balance between the electric field intensity E2 and the transmission loss Loss, the cases where interval L1 is 0.3 mm, 0.4 mm, and 0.5 mm are favorable, and the near field with the interval L1 less than λ/2π (approximately 0.61 mm) is preferable.

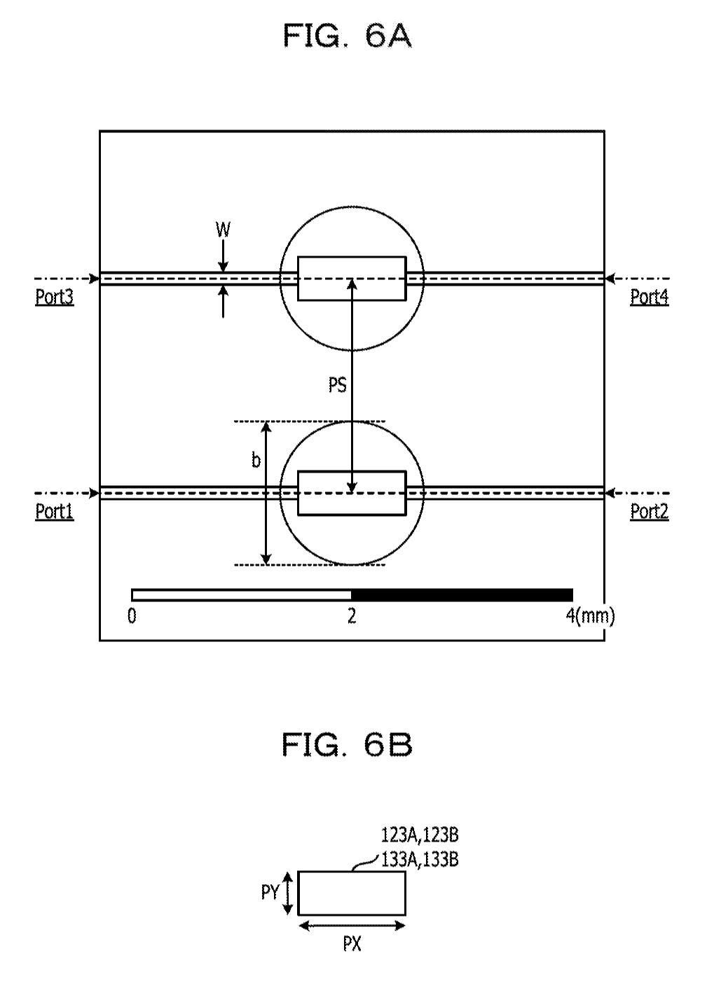

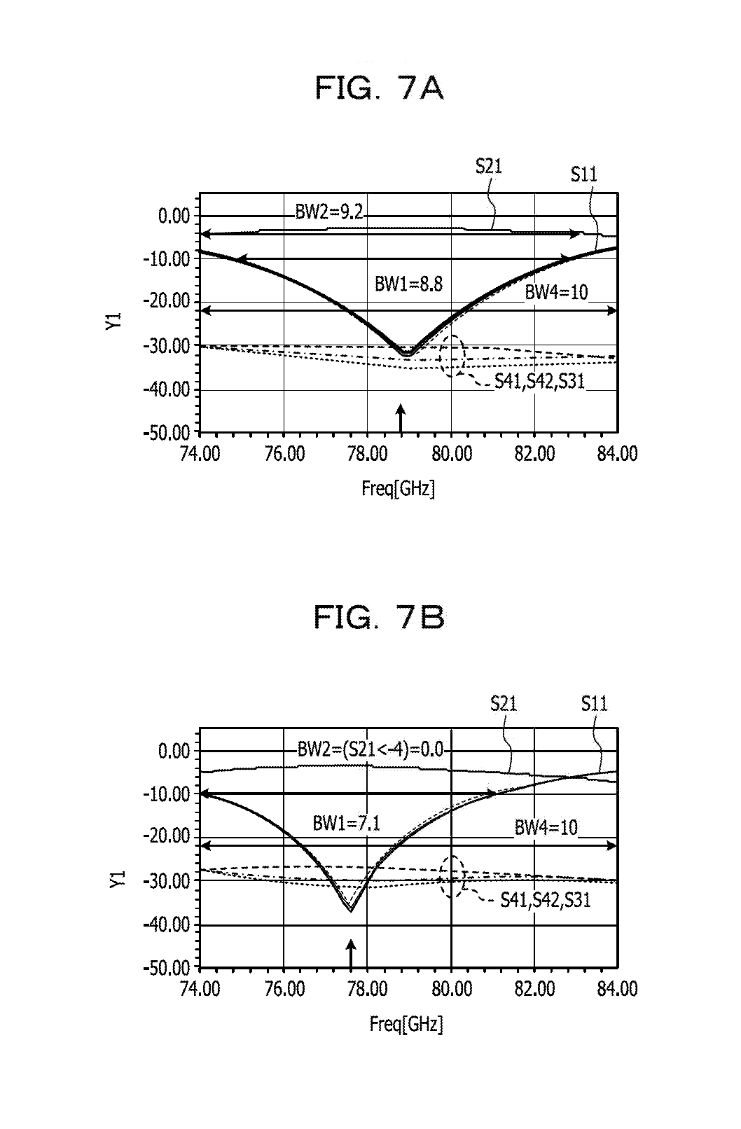

Subsequently, using FIGS. 6 to 8, results of simulation will be described. FIG. 6 is a diagram illustrating a model of simulation of the transmission apparatus 100. FIGS. 7A and 7B are each a graph illustrating results of a simulation of S-parameters and a bandwidth.

As illustrated in FIG. 6A, the diameter of through holes 111A and 111B is denoted by b, the line width of the wires 124A, 124B, 134A, and 134B by W, and the interval in the Y-axis direction between the centers of the patch antennae 123A and 123B and between the centers of the patch antennae 133A and 133B by PS. As illustrated in FIG. 6B, in addition, the length of the patch antennae 123A, 123B, 133A, and 133B in the X-axis direction (longitudinal direction) is denoted by PX, and the width thereof in the Y-axis direction (lateral direction) by PY.

The diameter b of the through holes 111A and 111B was set to 1.05 mm, the line width W to 0.04 mm, the thicknesses of the dielectric layer 122 and the dielectric layer 131 to 0.1 mm, the relative permittivities of the dielectric layer 122 and the dielectric layer 131 to 4.4 (tan δ=0.005). In addition, the thickness of the metal plate 110 (length of the through hole 111A) was set to 0.1 mm, and the interval PS to 2.0 mm.

Moreover, four combinations were prepared which have different intervals L1 between the patch antennae 123A and 133A in the Z-axis direction (intervals L1 between patch antennae 123B and 133B in the Z-axis direction). Note that since the resonant frequency F1 and the impedances of the patches change with the variation of the interval L1, the patch width PY and the length PX are varied to some degree such that F1 falls within a range from 77.6 to 78.8 GHz. Combination 1: interval L1=0.3 mm, length PX=0.8 mm, width PY=0.2 mm. Combination 2: interval L1=0.4 mm, length PX=0.7 mm, width PY=0.4 mm. Combination 3: interval L1=0.5 mm, length PX=0.7 mm, width PY=0.7 mm. Combination 4: interval L1=0.6 mm, length PX=0.6 mm, width PY=0.4 mm.

To obtain the S-parameters, the wire 124A was assigned to Port 1, the wire 134A to Port 2, the wire 124B to Port 3, and the wire 134B to Port 4.

FIG. 7A is a graph for the transmission apparatus 100 of Combination 2 (interval L1=0.4 mm, length PX=0.7 mm, width PY=0.4 mm), which illustrates frequency characteristics of S11-, S22-, S33-, S44-, and S21-parameters, where the S11-, S22-, S33-, and S44-parameters correspond to reflection characteristics of Ports 1, 2, 3, and 4, respectively, and the S21-parameter corresponds to the transmission loss between Port 1 and Port 2. Further, FIG. 7A illustrates frequency characteristics of S41-, S42-, and S31-parameters which correspond to an isolation between Port 1 and Port 4, an isolation between Port 2 and Port 4, and an isolation between Port 1 and Port 3, respectively.

Likewise, FIG. 7B is a graph illustrating the frequency characteristics of the S-parameters for the transmission apparatus 100 of Combination 3 (interval L1=0.5 mm, length PX=0.7 mm, width PY=0.7 mm).

Here, the band where the value of the reflection characteristic S11-parameter is less than −10 dB is represented as a bandwidth BW1. The band where the value of the transmission loss S21-parameter is greater than −4 dB is represented as a bandwidth BW2. Moreover, the band where the values of all of the isolation S41-, S42-, and S31-parameters are less than −26 dB is represented as a bandwidth BW4. Furthermore, the bandwidth which satisfies all the conditions BW1, BW2, and BW4 is represented as BW. Note that the definitions of BW1, BW2, BW4, and BW in the following drawings are the same.

The bandwidths BW1, BW2, and BW4 were 8.8 GHz, 9.2 GHz, and 10.0 GHz, respectively, in the case of the frequency characteristics of the S-parameters illustrated in FIG. 7A for the transmission apparatus 100 of Combination 2.

Since the value of BW4 is particularly favorable, the transmission path between Port 1 and Port 2, and the transmission path between Port 3 and Port 4 are established. Further, interference between the two transmission paths is suppressed. Hence, it is found that a certain level of isolation is obtained.

On the other hand, the bandwidths BW1, BW2, and BW4 were 7.1 GHz, 0.0 GHz, and 10.0 GHz, respectively, in the case of the frequency characteristics of the S-parameters illustrated in FIG. 7B for the transmission apparatus 100 of Combination 3.

BW1 and BW4 are not quite different from those in Combination 2, but BW2 was 0.0 GHz. This is because S21<−4 dB was satisfied due to the increase in transmission loss which depends on the interval L1.

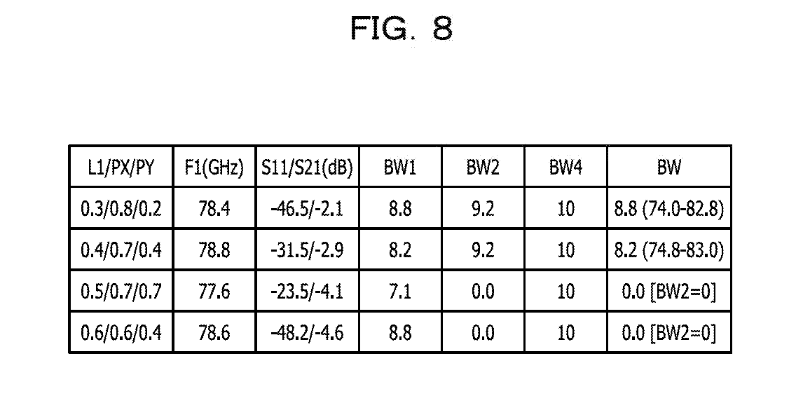

FIG. 8 is a diagram illustrating dependence of the resonant frequency F1, the S-parameters, BW1, BW2, BW4, and BW which is the bandwidth satisfying all the conditions, in the case where the interval L1 is varied from 0.3 to 0.6 mm.

When the interval L1 was increased from 0.3 to 0.6 mm in the combinations of FIG. 8, the value of the S11-parameter was favorable on the whole, but the value of the S21-parameter decreased to −4 dB or less in the cases of the interval L1 equal to 0.5 mm and 0.6 mm. For this reason, BW2 became 0.0 GHz.

The band BW, where all of the bandwidths BW1, BW2, and BW4 take values more favorable than the evaluation benchmarks described above, took the favorable values 8.8 and 8.2 in the cases of the interval L1 equal to 0.3 mm and 0.4 mm, respectively. BW2 was 0 in the cases of the interval L1 equal to 0.5 mm and 0.6 mm, however. Thus, BW became 0.0 in both cases.

Among Combinations 1 to 4 as described above, Combinations 1 and 2 were favorable, where the intervals L1 are 0.3 mm and 0.4 mm, respectively. Combinations 3 and 4, where the intervals L1 are 0.5 mm and 0.6 mm, respectively, had noticeably lower characteristics compared to Combinations 1 and 2.

From the above description, it is found that for Combinations 1 to 4, a favorable transmission characteristic may be obtained when the interval L1 is 0.4 mm or less.

In the first embodiment above, the transmission apparatus 100 is fabricated using the structure of what is called a wiring board to include the transmission path established by the patch antennae 123A and 133A, and the transmission path established by the patch antennae 123B and 133B.

As described above, the two transmission paths established by the pair of the patch antennae 123A and 133A and the pair of the patch antennae 123B and 133B have the interval L1 approximately ranging from 0.3 mm to 0.4 mm to enable communication in the near field in the case where the communication frequency is 78.0 GHz. In the case where the communication frequency is 78.0 GHz, the interval L1 is approximately 0.61 mm, which corresponds to the boundary between the near field and the far field.

Thus, in the transmission apparatus 100 of the first embodiment, when the interval L1 between the patch antennae 123A and 133A and between the patch antennae 123B and 133B is set to a value approximately ranging from 0.3 mm to 0.4 mm in the case where the communication frequency is 78.0 GHz, communication in the near field may be established between the patch antennae 123A and 133A and between the patch antennae 123B and 133B.

When the communication in the near field is to be established as described above, the interval L1 between the patch antennae 123A and 133A and between the patch antennae 123B and 133B is shortened.

Hence, according to the first embodiment, the downsized transmission apparatus 100, the downsized wireless communication apparatus 50, and the downsized wireless communication system 500 may be provided.

Moreover, since the transmission apparatus 100 is fabricated using the two boards 120 and 130 available at low prices, it is possible to reduce manufacturing costs. Thus, according to the first embodiment, the transmission apparatus 100, the wireless communication apparatus 50, and the wireless communication system 500 may be provided while reducing the manufacturing costs.

In the description above, the embodiment is described where the transmission apparatus 100 includes the transmission paths corresponding to two channels and being established by the patch antennae 123A, 123B, 133A, and 133B.

The transmission apparatus 100, however, may include even more patch antennae to have a configuration including transmission paths corresponding to three or more channels.

### Second Embodiment

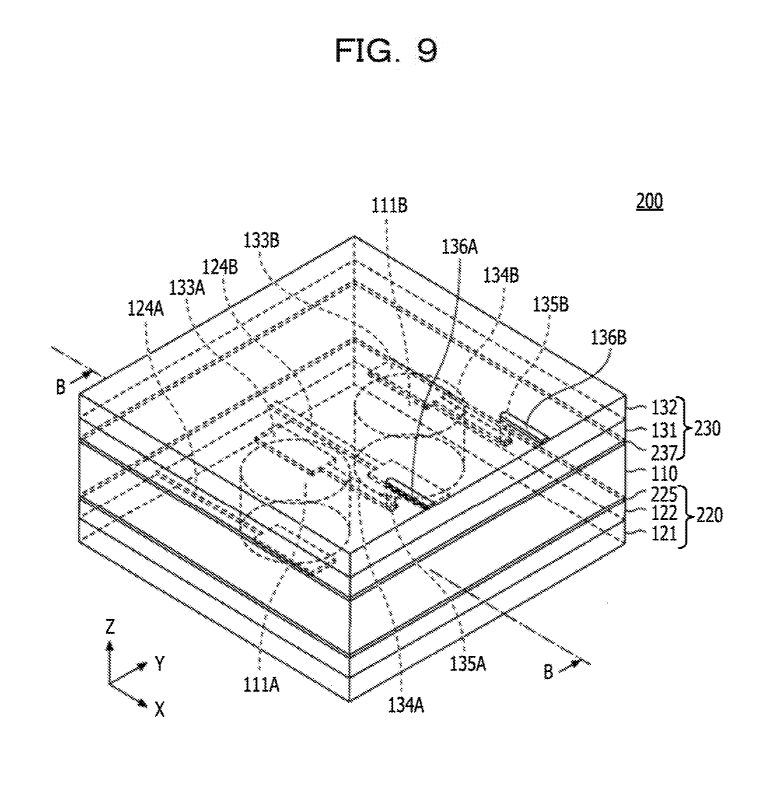

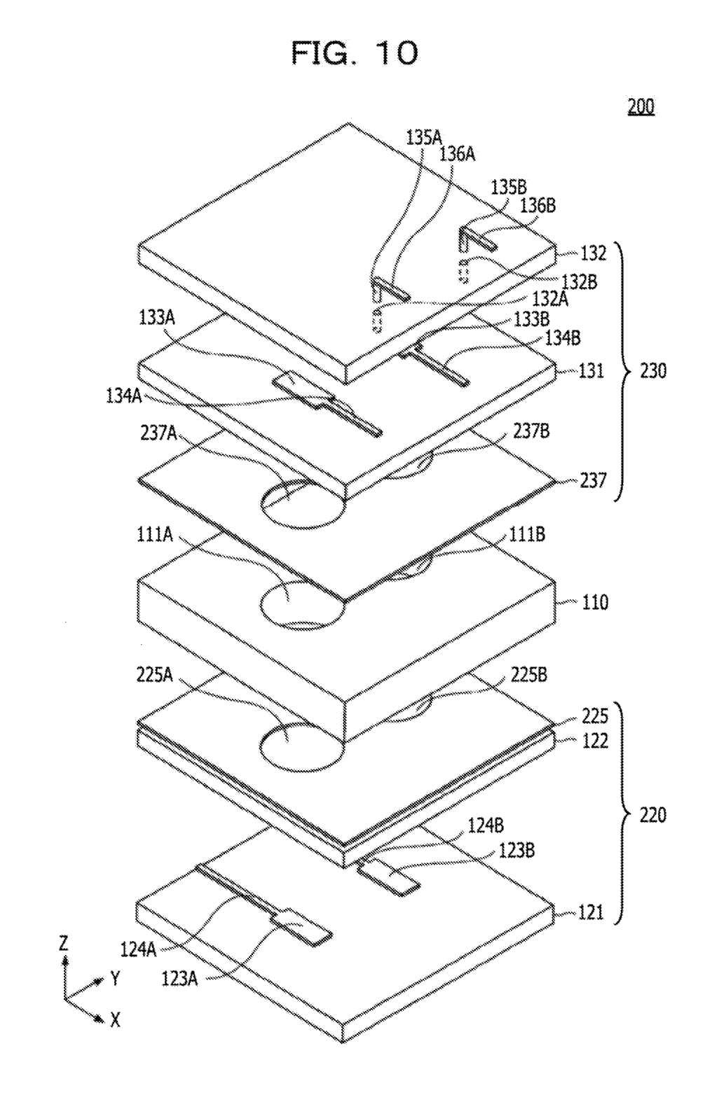

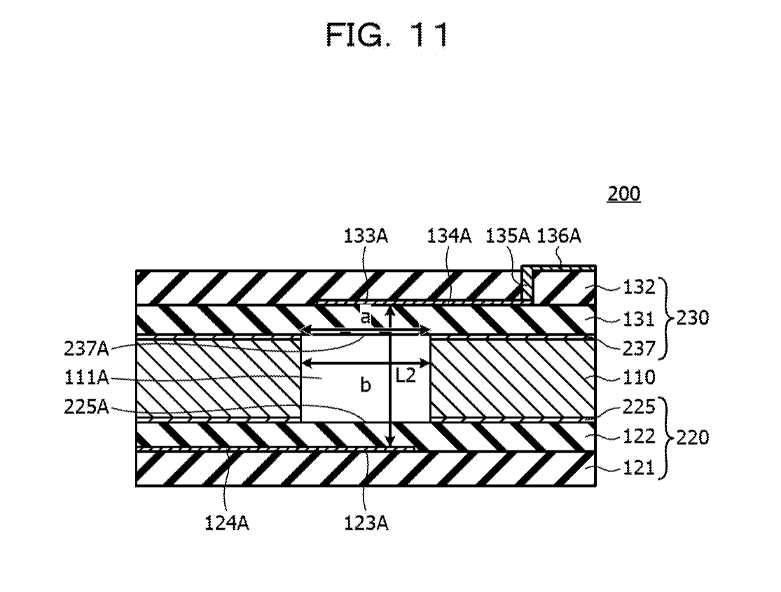

FIG. 9 is a transparent perspective view illustrating transmission apparatus 200 according to a second embodiment. FIG. 10 is an exploded view of the transmission apparatus 200 illustrated in FIG. 9. FIG. 11 is a diagram illustrating a cross-section viewed in the direction of arrows B in FIG. 9.

In the following description, as illustrated in FIGS. 9 to 11, an XYZ coordinate system (orthogonal coordinate system) is defined. Here, a surface on the negative Z-axis direction side is referred to as a lower surface, and a surface on the positive Z-axis direction side as an upper surface. Besides, the negative Z-axis direction side is referred to as a lower side, and the positive Z-axis direction side as an upper side. Note that the up-and-down relationship represented by the positive and negative Z-axis direction sides is for the sake of the convenience of explanation, but does not represent the general positional relationship.

Moreover, FIGS. 9 to 11 illustrate parts of the transmission apparatus 200. The transmission apparatus 200 may further extend in the XY plane directions.

The transmission apparatus 200 includes the metal plate 110, a board 220, and a board 230. The transmission apparatus 200 is the transmission apparatus 100 of the first embodiment with the board 120 and the board 130 replaced by the board 220 and the board 230, respectively.

The board 220 has a configuration of the board 120 of the first embodiment added with a metal layer 225. The board 230 has a configuration of the board 130 of the first embodiment added with a metal layer 237. The configuration in other respects is the same as that of the transmission apparatus 100 of the first embodiment. Thus, identical components are assigned the same reference signs, and their description is omitted.

The board 220 includes the dielectric layers 121 and 122, the patch antennae 123A and 123B, the wires 124A and 124B, and the metal layer 225. The board 220 may be an FR-4 printed board as an example.

The board 220 has a configuration of the board 120 of the first embodiment with the metal layer 225 added to the upper surface of the dielectric layer 122. Here, the wires 124A and 124B form microstrip lines together with the metal plate 110, and the metal layers 225 and 237.

The metal layer 225 has openings 225A and 225B. The openings 225A and 225B penetrate the metal layer 225 in the thickness direction (Z-axis direction), and have a circular shape in an XY-plan view (hereinafter, in a plan view), for example.

The positions of the openings 225A and 225B are aligned with the through holes 111A and 111B in the metal plate 110, respectively. In addition, the sizes of the openings 225A and 225B are the same as those of the through holes 111A and 111B, respectively.

The sizes of the openings 225A and 225B may be set such that the pair of the patch antennae 123A and 133A and the pair of the patch antennae 123B and 133B are enclosed in the plan view, respectively.

What is more, the impedances of the patch antennae 123A and 123B may be adjusted in particular, by changing the diameters of the openings 225A and 225B. In this case, the diameters of the openings 225A and 225B may be different depending on the corresponding impedances of the patch antennae 123A and 123B. The impedances of the patch antennae 123A and 123B may be optimized if the diameters of the openings 225A and 225B are set to the optimum values at the design phase.

The metal layer 225 may be copper foil, for example. The metal layer 225 is maintained at the ground potential because the upper surface thereof is connected to the metal plate 110. The metal layer 225 is an example of a first conductive layer, and the openings 225A and 225B are each an example of a first opening.

In the case of using the core material as the dielectric layer 122, the openings 225A and 225B in the metal layer 225 may be formed through patterning of copper foil to be attached on the upper surface of the dielectric layer 122 by, for example, photolithography and wet etching.

The board 230 includes the dielectric layers 131 and 132, the patch antennae 133A and 133B, the wires 134A and 134B, the vias 135A and 135B, wires 136A and 136B, and the metal layer 237. The board 230 may be an FR-4 printed board as an example.

The board 230 has a configuration of the board 130 of the first embodiment with the metal layer 237 added to the lower surface of the dielectric layer 131. Here, the wires 134A and 134B form microstrip lines together with the metal plate 110, and the metal layers 225 and 237.

The metal layer 237 has openings 237A and 237B. The openings 237A and 237B penetrate the metal layer 237 in the thickness direction (Z-axis direction), and have a circular shape in an XY-plan view (hereinafter, in a plan view), for example.

The positions of the openings 237A and 237B are aligned with the through holes 111A and 111B in the metal plate 110, respectively. In addition, the sizes of the openings 237A and 237B are the same as those of the through holes 111A and 111B, respectively.

The sizes of the openings 237A and 237B may be set such that the pair of the patch antennae 123A and 133A and the pair of the patch antennae 123B and 133B are enclosed in the plan view, respectively.

What is more, the impedances of the patch antennae 133A and 133B may be adjusted in particular, by changing the diameters of the openings 237A and 237B. In this case, the diameters of the openings 237A and 237B may be different depending on the corresponding impedances of the patch antennae 133A and 133B. The impedances of the patch antennae 133A and 133B may be optimized if the diameters of the openings 237A and 237B are set to the optimum values at the design phase.

The metal layer 237 may be copper foil, for example. The metal layer 237 is maintained at the ground potential because the lower surface thereof is connected to the metal plate 110. The metal layer 237 is an example of a second conductive layer, and the openings 237A and 237B are each an example of a second opening.

In the case of using the core material as the dielectric layer 131, the openings 237A and 237B in the metal layer 237 may be formed through patterning of copper foil to be attached on the lower surface of the dielectric layer 131 by, for example, photolithography and wet etching.

Subsequently, description will be provided for an interval in the Z-axis direction between the patch antennae 123A and 133A, and an interval in the Z-axis direction between the patch antennae 123B and 133B.

As illustrated in FIG. 11, the interval in the Z-axis direction between the patch antennae 123A and 133A is denoted by L2. Likewise, the interval in the Z-axis direction between the patch antennae 123B and 133B is denoted by L2. The interval L2 equals the sum of the thicknesses of the dielectric layer 122, the metal layer 225, the metal plate 110, the metal layer 237, and the dielectric layer 131.

In order to make possible communication between the patch antennae 123A and 133A in the near field, the interval L2 has to be such that the patch antennae 123A and 133A are communicably connected in the near field. This is the case when communication is to be established between the patch antennae 123B and 133B in the near field, and the interval L2 may thus be determined using the same consideration as that for the interval L1 in the first embodiment.

The dielectric layer 122, the opening 225A, the through hole 111A, the opening 237A, and the dielectric layer 131 are provided between the patch antennae 123A and 133A. Although air (atmosphere) is present inside the opening 225A, the through hole 111A, and the opening 237A, the wavelength shortens inside the dielectric layer 122 and the dielectric layer 131. Thus, the value of λ may be an electrical length taking into consideration the shortening of the wavelength. In the case where the thicknesses of the dielectric layer 122 and the dielectric layer 131 in the Z-axis direction are sufficiently thin compared to the lengths of the opening 225A, the through hole 111A, and the opening 237A in the Z-axis direction and thus are negligible, λ may be set to the length of one wavelength of the communication frequency in the air.

When the distance from each of the patch antennae 123A and 133A to the boundary between the near field and the far field is denoted by λ/2π, the interval L2 between the patch antennae 123A and 133A in the Z-axis direction may satisfy an expression (2) below:

L2<λ/2π (2).

In other words, the sum of the thicknesses of the dielectric layer 122, the metal layer 225, the metal plate 110, the metal layer 237, and the dielectric layer 131 may be less than λ/2π.

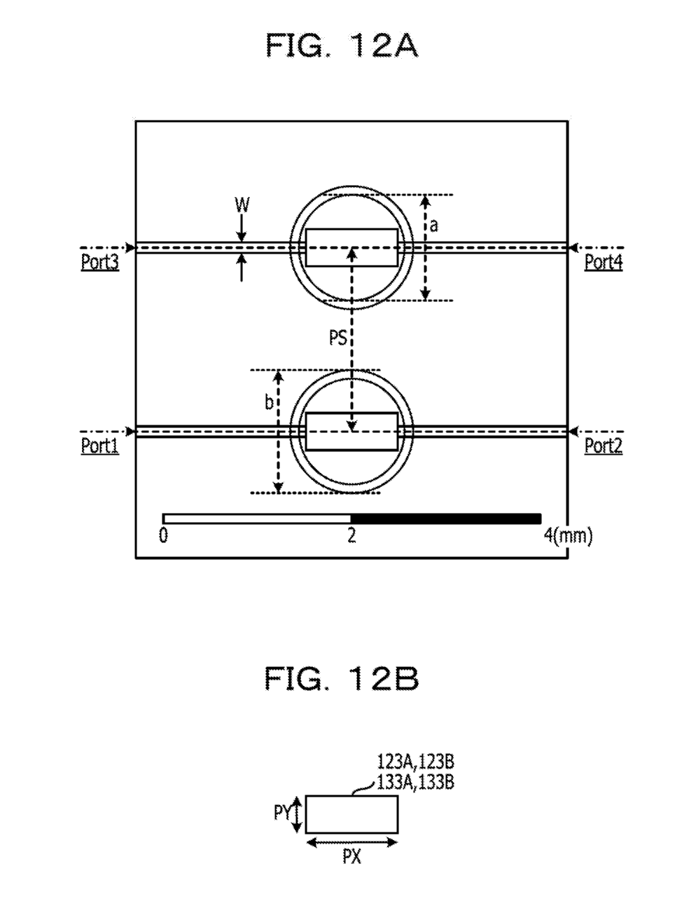

Subsequently, using FIGS. 12 to 14, results of simulation will be described.

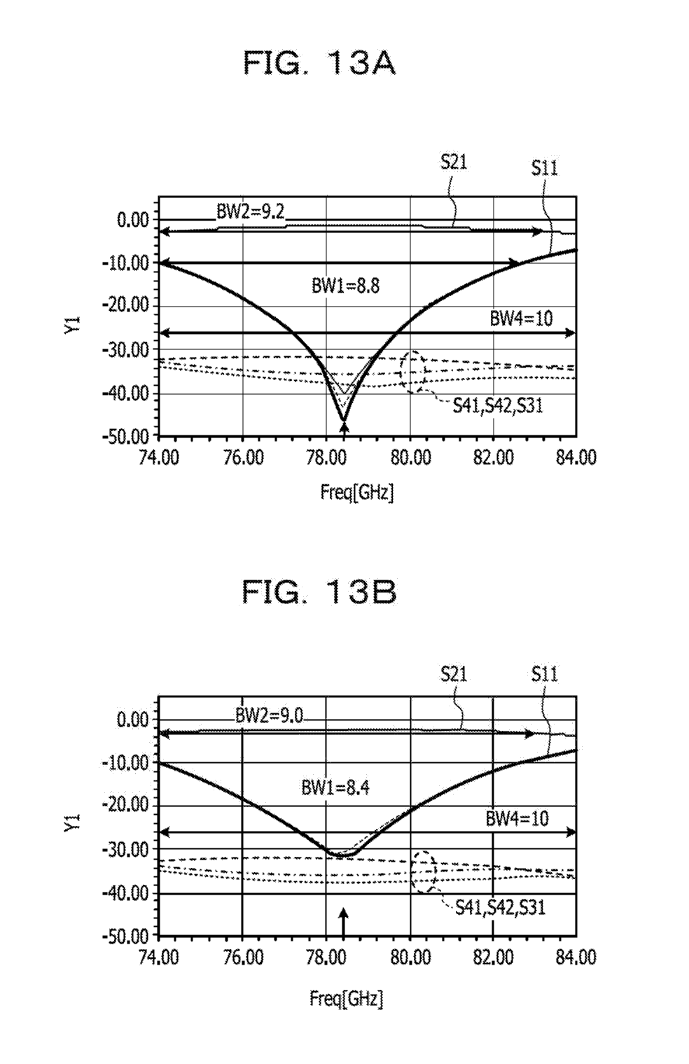

FIG. 12 is a diagram illustrating a model of simulation of the transmission apparatus 200. FIGS. 13A and 13B are each a graph illustrating results of a simulation of S-parameters and a bandwidth. The simulation was performed in the range where the communication frequency was around 78.0 GHz.

As illustrated in FIG. 12A, the diameter of through holes 111A and 111B is denoted by b, the diameter of the openings 225A, 225B, 237A, and 237B by a, the line width of the wires 124A, 124B, 134A, and 134B by W, the interval in the Y-axis direction between the centers of the patch antennae 123A and 123B and between the centers of the patch antennae 133A and 133B by PS. As illustrated in FIG. 12B, in addition, the length of the patch antennae 123A, 123B, 133A, and 133B in the X-axis direction (longitudinal direction) is denoted by PX, and the width thereof in the Y-axis direction (lateral direction) by PY.

The interval L2 between the patch antennae 123A and 133A in the Z-axis direction (interval L2 between patch antennae 123B and 133B in the Z-axis direction) was fixed to 0.3 mm. Additionally, the length PX and the width PY of the patch antennae 123A, 123B, 133A, and 133B are fixed to 0.8 mm and 0.2 mm, respectively.

The thicknesses of the dielectric layer 122 and the dielectric layer 131 were both set to 0.1 mm, the relative permittivity of the dielectric layer 122 and the dielectric layer 131 to 4.4 (tan δ=0.005), the thickness of the metal plate 110 (length of the through hole 111A) to 0.1 mm, the thickness of the metal layer 225 and 227 to 0.1 mm, and the line width W to 0.04 mm. In addition, the diameter a of the opening 225A, 225B, 237A, and 237B was set to 1.05 mm, and the interval PS to 2.0 mm.

Under the conditions above, the S-parameter were obtained as in the first embodiment, using models where the diameter b takes values 0.95 mm, 1.05 mm, 1.25 mm, 1.45 mm, and 1.65 mm.

In this case, one wavelength of the communication frequency equal to 78.0 GHz is approximately 3.84 mm, and the ¼ wavelength is approximately 0.96 mm. Hence, when the diameter b is 0.95 mm, the diameter of the through holes 111A and 111B is shorter than the ¼ wavelength of the communication frequency.

In addition, the ½ wavelength of the communication frequency equal to 78.0 GHz is approximately 1.92 mm. Hence, when the diameter b is 1.65 mm, the diameter of the through holes 111A and 111B is longer than the ¼ wavelength of the communication frequency and is shorter than the ½ wavelength of the communication frequency.

Incidentally, the assignment to Ports 1 to 4 is the same as that in the first embodiment.

FIG. 13A is a graph for the transmission apparatus 200 including the through holes 111A and 111B of diameter 1.05 mm, which illustrates frequency characteristics of S11-, S22-, S33-, S44-, and S21-parameters, where the S11-, S22-, S33-, and S44-parameters correspond to reflection characteristics of Ports 1, 2, 3, and 4, respectively, and the S21-parameter corresponds to the transmission loss between Port 1 and Port 2. Further, FIG. 13A illustrates frequency characteristics of S41-, S42-, and S31-parameters which correspond to an isolation between Port 1 and Port 4, an isolation between Port 2 and Port 4, and an isolation between Port 1 and Port 3, respectively.

FIG. 13B is a graph illustrating the frequency characteristics of the S-parameters for the transmission apparatus 200 including the through holes 111A and 111B of diameter 1.45 mm. Note that the evaluation axes of the bandwidth BW1, BW2, and BW4 are the same as those in the first embodiment.

The bandwidths BW1, BW2, and BW4 were 8.8 GHz, 9.2 GHz, and 10.0 GHz, respectively, in the case of the frequency characteristics of the S-parameters illustrated in FIG. 13A for the transmission apparatus 200 the through holes 111A and 111B of which have the diameter b equal to 1.05 mm.

Since the value of BW4 is particularly favorable, the transmission path between Port 1 and Port 2, and the transmission path between Port 3 and Port 4 are established. Further, interference between the two transmission paths is suppressed. Hence, it is found that a certain level of isolation is obtained.

On the other hand, the bandwidths BW1, BW2, and BW4 were 8.4 GHz, 9.0 GHz, and 10.0 GHz, respectively, in the case of the frequency characteristics of the S-parameters illustrated in FIG. 13B for the transmission apparatus 200 the through holes 111A and 111B of which have the diameter b equal to 1.45 mm.

Since the value of BW4 is particularly favorable, the transmission path between Port 1 and Port 2, and the transmission path between Port 3 and Port 4 are established. Further, interference between the two transmission paths is suppressed. Hence, it is found that a certain level of isolation is obtained.

In the model of the transmission apparatus 200 as described above, the transmission path between Port 1 and Port 2, and the transmission path between Port 3 and Port 4 are established. Further, interference between the two transmission paths is suppressed. Hence, it was found that a certain level of isolation is obtained.

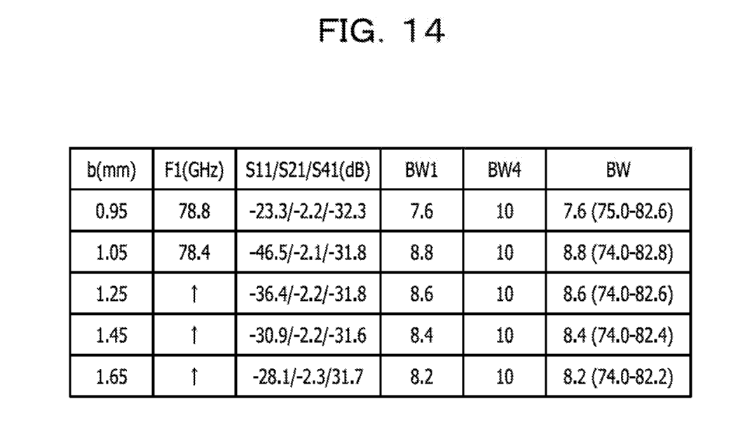

FIG. 14 is a diagram illustrating dependence of the resonant frequency F1, the S-parameters, BW1, BW4, and BW on the diameter b of through holes 111A, and 111B. When the diameter b of the through holes 111A and 111B was varied, the following facts were obtained.

When the diameter b was varied, the resonant frequency F1 remained substantially unchanged and the obtained values of the S11-parameter, the S21-parameter, and the S41-parameter were favorable on the whole.

Additionally, when the diameter b was 0.95 mm, BW1 took a small value, 7.6. This would be because the diameter b of the through holes 111A and 111B is shorter than the ¼ wavelength of the communication frequency.

When the diameter b was 1.05 mm, 1.25 mm, 1.45 mm, and 1.65 mm, BW1 took favorable values 8.8, 8.6, 8.4, and 8.2, respectively.

Additionally, BW4 was 10.0 GHz for all the cases where the diameter b was 0.95 mm, 1.05 mm, 1.25 mm, 1.45 mm, and 1.65 mm.

Thus, the band BW, where all of the bandwidths BW1, BW2, and BW4 take values more favorable than the evaluation benchmarks described above, took the favorable values 8.8, 8.6, 8.4, and 8.2 in the cases of the diameter b equal to 1.05 mm, 1.25 mm, 1.45 mm, and 1.65 mm.

In the models of the transmission apparatus 200 where the diameter b was set to 0.95 mm, 1.05 mm, 1.25 mm, 1.45 mm, and 1.65 mm, favorable values of BW were obtained when the diameter b was set to 1.05 mm, 1.25 mm, 1.45 mm, and 1.65 mm.

A stable value of BW may be obtained regardless of the value of the diameter b. This means that even if the through hole 111A is displaced with respect to the openings 225A and 237A and the through hole 111B is displaced with respect to the openings 225B and 237B, the influence on BW is small.

Among the models of the transmission apparatus 200 where the diameter b was set to 0.95 mm, 1.05 mm, 1.25 mm, 1.45 mm, and 1.65 mm, it was found that a favorable transmission characteristic may be obtained when the diameter b was set to 1.05 mm, 1.25 mm, 1.45 mm, and 1.65 mm.

Assuming the case where the through holes 111A and 111B function as circular waveguides, description is provided, by calculation of the cutoff frequency, for the communication between the patch antennae 123A and 133A and between the patch antennae 123B and 133B in the near field.

If the cylindrical portion formed of the opening 225A, the through hole 111A, and the opening 237A functions as a circular waveguide in the TE11 mode, the cutoff frequency Fc is calculated in the following manner.

The cutoff frequency Fc is given by Fc=c/λc, where c is the speed of light. In the case of a circular waveguide, the cutoff wavelength λc is given as the diameter b multiplied by 1.706. Hence, λc=1.706b.

When the cutoff frequency Fc is obtained by plugging 1.05 mm, 1.25 mm, 1.45 mm, 1.65 mm into the diameter b, the smallest cutoff frequency Fc is approximately 106.5 GHz with the diameter b equal to 1.65 mm.

Hence, assuming that the cylindrical portion formed of the opening 225A, the through hole 111A, and the opening 237A functions as the circular waveguide in the TE11 mode, it is not possible for such a circular waveguide to transmit a radio wave with the communication frequency equal to 78.0 GHz.

For the above reason, the characteristic illustrated in FIG. 14 and obtained by setting the communication frequency to 78.0 GHz was obtained in a mode other than that of a circular waveguide.

It is found from this result that the pair of the patch antennae 123A and 133A and the pair of the patch antennae 123B and 133B communicate respectively in the near field. Here, description is provided using the case for comparison where the through hole 111A and the openings 225A and 237A function as a circular waveguide, and the through hole 111B and the openings 225B and 237B function as a circular waveguide. However, the above description may be applied to the case where the metal layers 225 and 237 are not included as in the first embodiment.

In the second embodiment above, the transmission apparatus 200 is fabricated using the structure of what is called a wiring board to include the transmission path established by the patch antennae 123A and 133A, and the transmission path established by the patch antennae 123B and 133B.

As described above, the two transmission paths established by the pair of the patch antennae 123A and 133A and the pair of the patch antennae 123B and 133B have the interval L2 approximately ranging from 0.3 mm to 0.4 mm to enable communication in the near field in the case where the communication frequency is 78.0 GHz.

In the case where the communication frequency is 78.0 GHz, the interval L1 is approximately 0.61 mm, which corresponds to the boundary between the near field and the far field.

Thus, in the transmission apparatus 200 of the second embodiment, when the interval L2 between the patch antennae 123A and 133A and between the patch antennae 123B and 133B is set to a value approximately ranging from 0.3 mm to 0.4 mm in the case where the communication frequency is 78.0 GHz, communication in the near field may be established between the patch antennae 123A and 133A and between the patch antennae 123B and 133B.

When the communication in the near field is to be established as described above, the interval L2 between the patch antennae 123A and 133A and between the patch antennae 123B and 133B is shortened. Such a short interval is impossible when a waveguide is used.

Hence, according to the second embodiment, the downsized transmission apparatus 200, the downsized wireless communication apparatus 50, and the downsized wireless communication system 500 may be provided.

Further, the transmission apparatus 200 of the second embodiment has a configuration where the metal plate 110 is sandwiched between the metal layers 225 and 237. The metal layers 225 and 237 have the pair of the openings 225A and 225B, and the pair of the openings 237A and 237B, respectively.

The pair of the openings 225A and 237A and the pair of the openings 225B and 237B are provided corresponding to the through holes 111A and 111B of the metal plate 110, respectively.

For this reason, the impedances of the patch antennae 123A, 123B, 133A, and 133B are adjusted by the metal layers 225 and 237 as well. Thus, the transmission apparatus 200, the wireless communication apparatus 50, and the wireless communication system 500 with a more favorable transmission characteristic may be provided.

Moreover, since the transmission apparatus 200 is fabricated using the two boards 220 and 230 available at low prices, it is possible to reduce manufacturing costs. Thus, according to the second embodiment, the transmission apparatus 200, the wireless communication apparatus 50, and the wireless communication system 500 may be provided while reducing the manufacturing costs.

In the description above, the transmission apparatus 200 including the metal layers 225 and 237 is provided. However, the transmission apparatus 200 may have a configuration where only one of the metal layers 225 and 237 is included.

In the description above, the transmission apparatus 200 including the metal plate 110 is provided. However, the transmission apparatus 200 may have a configuration where the metal layers 225 and 237 are directly bonded to each other without including the metal plate 110.

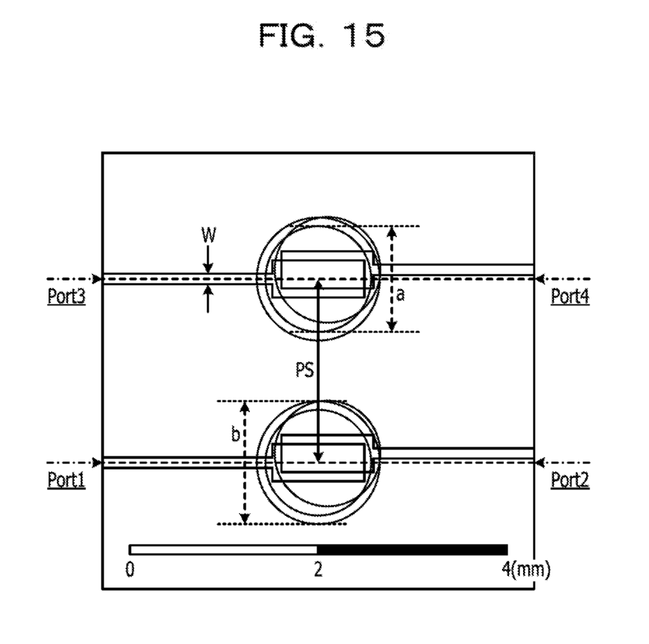

Subsequently, using FIGS. 15 to 17, description of the results of simulation is provided, as a first modified example of the second embodiment, for the case where the openings 225A and 237A are displaced with respect to the through hole 111A, and the openings 225B and 237B are displaced with respect to the through hole 111B.

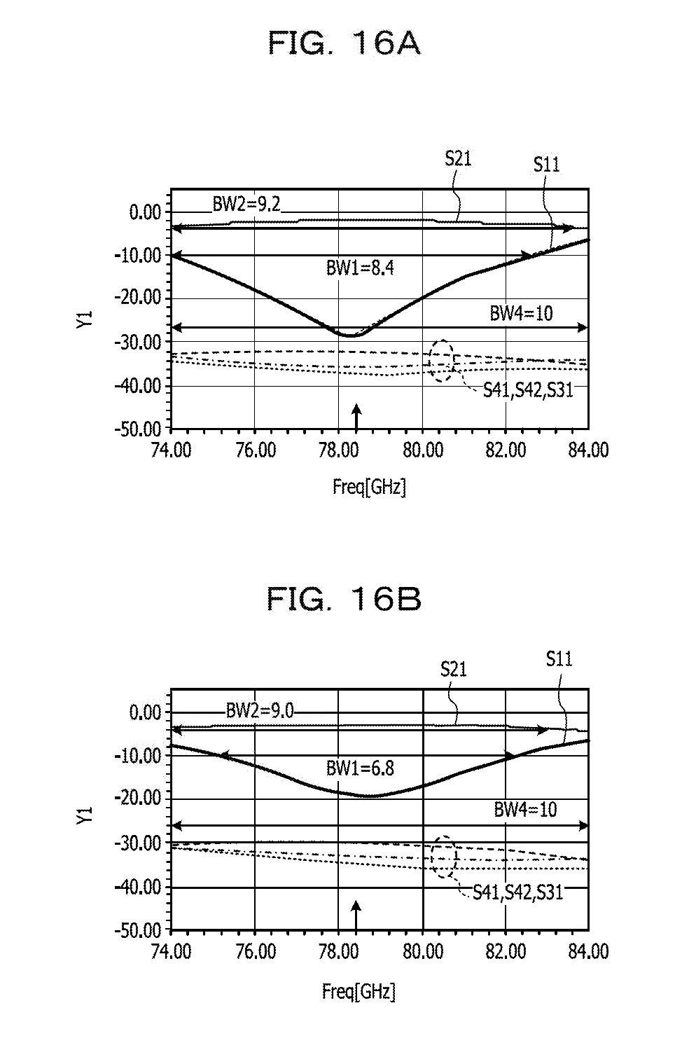

FIG. 15 is a model of simulation of the transmission apparatus 200 according to the first modified example of the second embodiment. FIGS. 16A and 16B are each a graph illustrating results of a simulation of the S-parameters and the bandwidth. The simulation was performed in the range where the communication frequency was around 78.0 GHz.

In the first modified example of the second embodiment as illustrated in FIG. 15, the openings 225A and 237A are displaced with respect to the through hole 111A, and the openings 225B and 237B are displaced with respect to the through hole 111B. Those displacements

Here, evaluation was performed assuming that the board 120 was not displaced with respect to the metal plate 110, and the board 130 was displaced with respect to the metal plate 110 in the X-axis direction and in the Y-axis direction by DX and DY, respectively.

In addition, the diameter b of the through holes 111A and 111B was fixed to 1.65 mm. The other conditions are the same as those for the simulation the results of which are illustrated in FIGS. 12 to 14.

FIG. 16A is a graph illustrating the frequency characteristics of the S-parameters for the transmission apparatus 200 with both of the displacement DX and the displacement DY equal to 0.0 mm.

FIG. 16B is a graph illustrating the frequency characteristics of the S-parameters for the transmission apparatus 200 with both of the displacement DX and the displacement DY equal to 0.2 mm.

The bandwidths BW1, BW2, and BW4 were 8.4 GHz, 9.0 GHz, and 10.0 GHz, respectively, in the case of the frequency characteristics of the S-parameters illustrated in FIG. 16A for the transmission apparatus 200 with the displacement DX and the displacement DY equal to 0.0 mm.

Since the value of BW4 is particularly favorable, the transmission path between Port 1 and Port 2, and the transmission path between Port 3 and Port 4 are established. Further, interference between the two transmission paths is suppressed. Hence, it is found that a certain level of isolation is obtained.

Besides, the bandwidths BW1, BW2, and BW4 were 6.8 GHz, 9.0 GHz, and 10.0 GHz, respectively, in the case of the frequency characteristics of the S-parameters illustrated in FIG. 16B for the transmission apparatus 200 with the displacement DX and the displacement DY equal to 0.2 mm.

Although the value of the BW1 decreased, the values of the BW2 and BW4 obtained were the same as those for the model where displacement DX and the displacement DY are 0.0 mm.

It was found as described above that approximately 0.2 mm of the displacement DX and the displacement DY are within the tolerable range. Considering potential displacements in the actual manufacturing steps, a margin of approximately 0.2 mm is very effective.

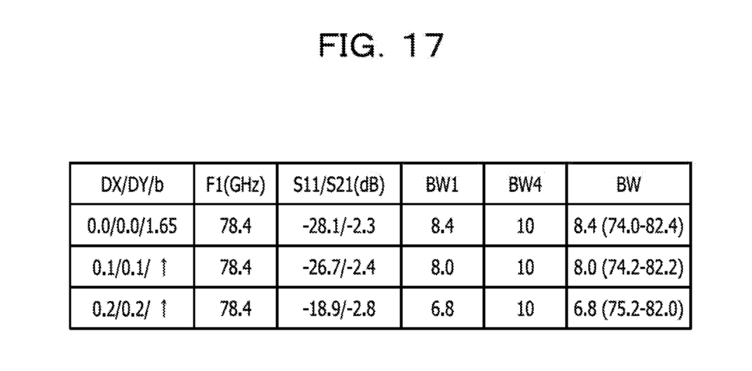

FIG. 17 is a diagram illustrating dependence of the resonant frequency F1, the S-parameters, BW1, BW4, and BW on the displacement DX and the displacement DY. When the displacement DX and the displacement DY were changed, the following facts were obtained.

When the displacement DX and the displacement DY were varied, the resonant frequency F1 remained unchanged and the obtained values of the S11-parameter and the S21-parameter were favorable on the whole.

Even though the displacement DX and the displacement DY were increased to 0.2 mm, a sufficient value, 6.8 GHz, was obtained for the band BW where all of the bandwidths BW1, BW2, and BW4 take values more favorable than the evaluation benchmarks described above.

It was found from above that approximately 0.2 mm of the displacement DX and the displacement DY are within the tolerable range. This would also be the case with the displacement of the board 120 with respect to the metal plate 110.

In the transmission apparatus 200, it is preferable that all of the centers of the patch antenna 123A, the patch antenna 133A, the through hole 111A, the opening 225A, and the opening 237A are aligned with one another, and all of the centers of the patch antenna 123B, the patch antenna 133B, the through hole 111B, the opening 225B, and the opening 237B are aligned with one another.

However, when the board 220 and the board 230 are to be bonded to the metal plate 110, or when the board 220 or the board 230 is to be fabricated, a displacement might occur. Even in those cases, it is possible to provide the transmission apparatus 200 capable of obtaining a favorable transmission characteristic. Note that the tolerance to such a displacement is expected to be obtained in the same manner as in the transmission apparatus 100 of the first embodiment.

Hence, according to the first modified example of the second embodiment, it is possible to provide the downsized transmission apparatus 200, the downsized wireless communication apparatus 50, and the downsized wireless communication system 500, which are capable of obtaining a favorable transmission characteristic even if the board 120 or 130 is displaced with respect to the metal plate 110 in the manufacturing process.

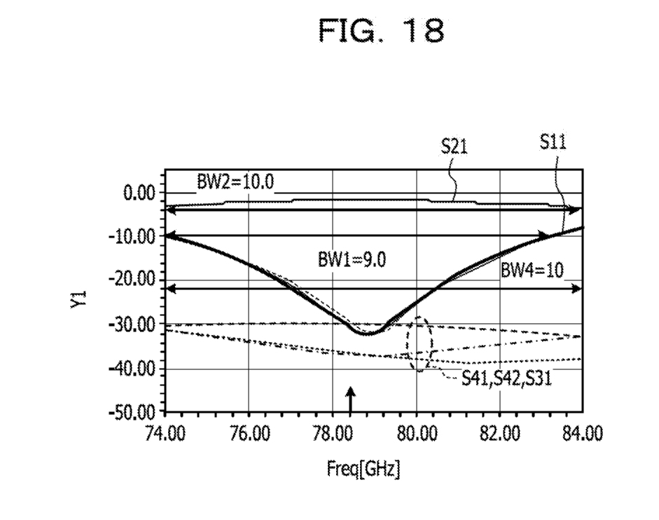

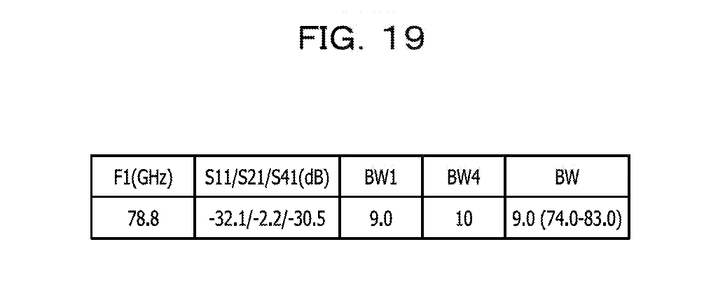

Subsequently, using FIGS. 18 and 19, results of simulation according to a second modified example of the second embodiment will be described.

FIG. 18 is a graph illustrating results of a simulation of the S-parameters and the bandwidth in the second modified example of the second embodiment. The simulation was performed in the range where the communication frequency was around 78.0 GHz.

In the second modified example of the second embodiment, the relative permittivity of the dielectric layer 122 was set to 2.4 (tan δ=0.00009), and the relative permittivity of the dielectric layer 131 to 4.4 (tan δ=0.005).

In addition, the diameter a of the openings 225A and 225B was set to 1.05 mm, the line width W of the wires 124A and 124B to 0.04 mm, the length PX of the patch antennae 123A and 123B in the longitudinal direction to 0.81 mm, and the width PY thereof in the lateral direction to 0.2 mm.

Moreover, the diameter a of the openings 237A and 237B was set to 1.35 mm, the line width W of the wires 134A and 134B to 0.08 mm, the length PX of the patch antennae 133A and 133B in the longitudinal direction to 1.1 mm, and the width PY thereof in the lateral direction to 0.3 mm.

Incidentally, the other numerical values are the same as those for the models the results of simulation of which are illustrated in FIGS. 12 to 14.

The bandwidths BW1, BW2, and BW4 were 9.0 GHz, 10.0 GHz, and 10.0 GHz, respectively, in the case of the frequency characteristics of the S-parameters illustrated in FIG. 18.

All of the bandwidths BW1, BW2, and BW4 are improved, and the transmission path between Port 1 and Port 2 and the transmission path between Port 3 and Port 4 are established. Further, interference between the two transmission paths is suppressed. Hence, it is found that a certain level of isolation is obtained.

FIG. 19 is a diagram illustrating dependence of the resonant frequency F1, the S-parameters, BW1, BW4, and BW in the second modified example of the second embodiment.

The resonant frequency F1 was 78.8 GHz, and the obtained values of the S11-parameter, the S21-parameter, and the S41-parameter were favorable.

A favorable value, 9.0 GHz, was obtained for the band BW where all of the bandwidths BW1, BW2, and BW4 take values more favorable than the evaluation benchmarks described above.

The above results demonstrate that a favorable transmission characteristic may be obtained even in the case where the relative permittivities of the dielectric layer 122 and the dielectric layer 131 are different from each other.

Hence, according to the second modified example of the second embodiment, it is possible to provide the downsized transmission apparatus 200, the downsized wireless communication apparatus 50, and the downsized wireless communication system 500, which are capable of obtaining a favorable transmission characteristic even in the case where the relative permittivities of the dielectric layer 122 and the dielectric layer 131 are different from each other.

### Third Embodiment

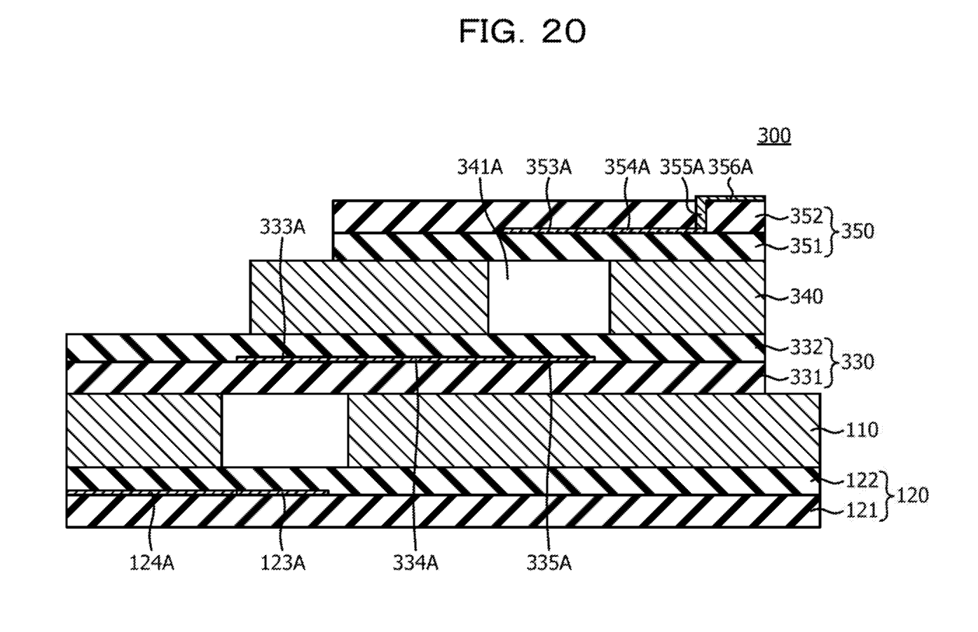

FIG. 20 is a cross-sectional view illustrating transmission apparatus 300 according to a third embodiment. The cross-section illustrated in FIG. 20 corresponds to the cross-section illustrated in FIG. 4.

The transmission apparatus 300 includes the metal plate 110, the board 120, a board 330, a metal plate 340, and a board 350. The transmission apparatus 300 has a configuration where the three boards 120, 330, and 350 are stacked. The metal plate 110 and the board 120 are the same as the metal plate 110 and the board 120 in the first embodiment.

The board 330 includes dielectric layers 331 and 332, a patch antenna 333A, a wire 334A, and a patch antenna 335A. The board 330 has a configuration where the via 135A and the wire 136A are removed from the board 130 of the first embodiment, and the patch antenna 335A is added thereto.

The board 330 is an example of the second board, the patch antenna 333A is an example of the second patch antenna, and the patch antenna 335A is an example of a fourth patch antenna.

The dielectric layers 331 and 332, and the patch antenna 333A are the same as the dielectric layers 131 and 132, and the patch antenna 133A in the first embodiment, respectively. Besides, the wire 334A is a wire which connects the patch antenna 333A to the patch antenna 335A, and forms a microstrip line together with the metal plates 110 and 340.

The patch antenna 335A is aligned with a through hole 341A in the metal plate 340 in the plan view. This positional relationship is the same as that between the patch antenna 123A and the through hole 111A.

The metal plate 340 is disposed on an upper surface of the board 330, and includes the through hole 341A. The metal plate 340 is an example of a second metal plate. The position of the through hole 341A in the plan view is aligned with the patch antennae 335A and 353A. The metal plate 340 is the same as the metal plate 110 including the through holes 111A and 111B.

The board 350 includes dielectric layers 351 and 352, a patch antenna 353A, a wire 354A, a via 355A, and a wire 356A. The board 350 is an example of a third board, and the patch antenna 353A is an example of a third patch antenna.

The board 350 is the same as the board 130 of the first embodiment. In other words, the dielectric layers 351 and 352, the patch antenna 353A, the wire 354A, the via 355A, and the wire 356A are the same as the dielectric layers 131 and 132, the patch antenna 133A, the wire 134A, the via 135A, and the wire 136A, respectively.

The patch antenna 353A is aligned with a through hole 341A in the metal plate 340 in the plan view. Meanwhile, the interval between the patch antenna 353A and the patch antenna 335A in the Z-axis direction is set such that communication in the near field is possible. Thus, the patch antenna 353A may communicate with the patch antenna 335A in the near field.

The patch antenna 353A is connected to the wire 356A through the wire 354A and the via 355A. The wire 356A is connected to the antenna 510 illustrated in FIG. 1.

Thus, in the transmission apparatus 300 with the above configuration, communication in the near field is possible between the patch antenna 123A and the patch antenna 333A, and the patch antenna 333A and the patch antenna 335A are connected to each other through the wire 354A forming the microstrip line. Furthermore, communication in the near field is possible between the patch antenna 353A and the patch antenna 335A.

Hence, also in the configuration where the three boards 120, 330, and 350 are stacked, it is possible to provide the downsized transmission apparatus 300 which allows communication in the near field between the patch antenna 123A and the patch antenna 333A, and between the patch antenna 353A and the patch antenna 335A.

The description has been provided as above for the exemplary transmission apparatus, wireless communication apparatuses, and wireless communication systems of the embodiments of the disclosure. However, the disclosure is not limited to the embodiments specifically disclosed, and various modifications and changes may be made without departing from the scope of the claims.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A transmission apparatus comprising:
a first metal plate including a first surface, a second surface opposite to the first surface, and a first through hole penetrating from the first surface to the second surface, the first metal plate being maintained at a reference potential;
a first board being disposed on the first surface side of the first metal plate, the first board including a first patch antenna positioned inside the first through hole in a plan view; and
a second board being disposed on the second surface side of the first metal plate, the second board including a second patch antenna positioned inside the first through hole in the plan view and opposed to the first patch antenna, wherein an interval between the first patch antenna and the second patch antenna is set in accordance with a distance for wireless communicating between the first patch antenna and the second patch antenna in a near field.

2. The transmission apparatus according to claim 1, wherein the interval between the first patch antenna and the second patch antenna is less than λ/2π, where λ denotes a wavelength of a frequency at which the first patch antenna and the second patch antenna communicate with each other.

3. The transmission apparatus according to claim 1, wherein
the first through hole has a circular shape in the plan view, and
a diameter of the first through hole is greater than λ/4, where λ denotes a wavelength of a frequency at which the first patch antenna and the second patch antenna communicate with each other.

4. The transmission apparatus according to claim 1, wherein
the first board is a first conductive layer disposed on the first surface side of the first metal plate and further includes a first opening communicating with the first through hole, and
the second board is a second conductive layer disposed on the second surface side of the first metal plate and further includes a second opening communicating with the first through hole.

5. The transmission apparatus according to claim 1, further comprising:
a second metal plate being disposed on a side of the second board opposite from the first metal plate, the second metal plate being maintained at the reference potential, the second metal plate including a second through hole opened at a position not overlapping the first through hole in the plan view; and
a third board being disposed on a side of the second metal plate opposite from the second board, the third board including a third patch antenna positioned inside the second through hole in the plan view, wherein
the second board includes a wire connected to the second patch antenna and a fourth patch antenna connected to the wire, the fourth patch antenna being positioned inside the second through hole in the plan view, the fourth patch antenna being opposed to the third patch antenna, and
an interval between the third patch antenna and the fourth patch antenna is set in accordance with the distance for wireless communicating between the third patch antenna and the fourth patch antenna in the near field.

6. A wireless communication apparatus comprising:
a first metal plate including a first surface, a second surface opposite to the first surface, and a first through hole penetrating from the first surface to the second surface, the first metal plate being maintained at a reference potential;
a first board being disposed on the first surface side of the first metal plate, the first board including a first patch antenna positioned inside the first through hole in a plan view;
an integrated circuit configured to execute a wireless frontend process of transmitting signal or received signal, the integrated circuit being coupled to the first patch antenna through a wire disposed in the first metal plate; and
a second board being disposed on the second surface side of the first metal plate, the second board including a second patch antenna positioned inside the first through hole in the plan view and opposed to the first patch antenna, wherein an interval between the first patch antenna and the second patch antenna is set in accordance with a distance for wireless communicating between the first patch antenna and the second patch antenna in a near field.

7. A wireless communication system comprising:
a first metal plate including a first surface, a second surface opposite to the first surface, and a first through hole penetrating from the first surface to the second surface, the first metal plate being maintained at a reference potential;
a first board being disposed on the first surface side of the first metal plate, the first board including a first patch antenna positioned inside the first through hole in a plan view;
an antenna configured to transmit millimeter wave, the antenna being coupled to the second patch antenna through a wire being disposed in the first board;
an integrated circuit configured to execute a wireless frontend process of transmitting signal or received signal, the integrated circuit being coupled to the first patch antenna through a wire disposed in the first metal plate; and
a second board being disposed on the second surface side of the first metal plate, the second board including a second patch antenna positioned inside the first through hole in the plan view and opposed to the first patch antenna, wherein an interval between the first patch antenna and the second patch antenna is set in accordance with a distance for wireless communicating between the first patch antenna and the second patch antenna in a near field.
